(19) United States
(12) Patent Application Publication
(10) Pub. No.: US 2007/0138223 A1
(43) Pub. Date: Jun. 21, 2007

(54) GOLF BAG FOR MOTORCYCLES

(76) Inventor: Bret R. Brown, Highland Village, TX (US)

Correspondence Address: Michael A. O'Neil;Michael A. O'Neil, P.C., Suite 820, 5949 Sherry Lane, Dallas, TX, 75225, US

(21) Appl. No.: 11/465,146

(22) Filed: Aug. 17, 2006

Related U.S. Application Data
(60) Provisional application No. 60/751,527, filed on Dec. 19, 2005.

(51) Int. Cl. A63B 55/00; B62J 9/00; B62J 11/00

(52) U.S. Cl. 224/413; 224/423; 224/450; 206/315.3

(57) ABSTRACT

A device for safely and efficiently transporting golf clubs on motorcycles wherein the golf bag is separable into two equal halves that are supported on opposite sides of the motorcycle for transport and are then secured together to form a single golf bag for use in the traditional manner to transport a plurality of golf clubs during the playing of golf.

### CROSS-REFERENCE TO RELATED APPLICATIONS

This application claims priority based on provisional patent application Ser. No. 60/751,527 filed Dec. 19, 2005, the entire contents of which are incorporated herein by reference.

### TECHNICAL FIELD

This invention relates generally to transporting golf clubs, and more specifically to transporting golf clubs on motorcycles.

### BACKGROUND AND SUMMARY OF THE INVENTION

From the beginning of the game of golf players have used various devices to transport their golf clubs to, from, and around golf courses. Golf bags, as they have come to be called, are well known in the art. Typically the height of golf bags is proportional to the length of the golf clubs that are inserted into the bag from the top and the diameter of golf bags is suitable for holding an entire set of golf clubs, or some portion thereof. Golf bags commonly have various pockets for holding golf accessories such as golf balls, tees, gloves, etc. Golf bags typically have a rigid base and a frame sturdy enough that the open top of the golf bags does not fall down around the golf clubs. The materials that are used in manufacture of golf bags vary widely and include leather, canvas, synthetic materials, etc.

In parallel with the ever increasing interest in golf interest in motorcycle riding has steadily increased. For as long as motorcycles have been used as a mode of transportation motorcycle riders have sought the ability to store and transport various articles on their motorcycles. By definition, motorcycles do not have the storage space that characterizes even the smallest traditional automobiles. A further complication comprises the fact that articles transported on motorcycles must be balanced so as not to create dangerous conditions for motorcycle riders and passengers. The most common storage devices used on motorcycles are saddle-bags, which are two equally sized bags that are placed on opposite sides of the motorcycle to provide the necessary balance. Saddle-bags are well known in the art and can be rigid or pliable. It is also known to use trailers to store and transport larger items, but trailers are expensive and add complications to the operation of the motorcycles.

Heretofore motorcycle riders wanting to transport golf bags have not had a safe, efficient, and inexpensive way of doing so. Golf bags are somewhat large in relation to the size of most motorcycles and will not fit inside storage compartments such as traditional saddle-bags. Further, the size and weight of traditional golf bags would imbalance motorcycles even if attached thereto or if simply held by the motorcycle rider or passenger.

The present invention addresses the above-described problems by providing golf bags for transporting golf clubs on motorcycles. In accordance with the invention golf bags are constructed in two complimentary halves that are attached to either side of a motorcycle and positioned substantially behind the rider seated on the motorcycle. The two halves of the golf bag are attached to motorcycles using conventional means for attaching saddle-bags and other existing devices. Alternatively, the two halves of the golf bag may be received and transported in specially designed saddle-bags.

The two halves of the golf bag each receive a substantially equal number of golf clubs to provide balance, and the ends thereof through which the golf clubs are received are covered with an end cap for transportation and storage. Golf bags incorporating the invention are constructed of materials suitable for withstanding damage from the elements and from debris as motorcycles travel on the open road.

A significant feature of the invention is that the two halves of the golf bag can be removed from the motorcycles and attached together to form a complete golf bag once the motorcycle rider has reached the intended destination. The resulting unitary golf bag is then used to carry golf clubs around golf courses in the conventional manner.

The invention can also be used for transporting other objects that can fit inside golf bags of typical size. Examples of such objects include rifles and shotguns.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating the two halves of the golf bag of the present invention attached to the sides of a motorcycle;

FIG. 2 is an exploded view illustrating a first embodiment of the attachment of one half of the golf bag of the present invention to one side of a motorcycle;

FIG. 3 is an exploded view illustrating a second embodiment of the attachment of one half of the golf bag of the present invention to one side of a motorcycle;

FIG. 4 is a partial view of a method of attaching the two halves of a golf bag of the present invention one to the other;

FIG. 5 is full view further illustrating the method of attaching the two halves of a golf bag of FIG. 4;

FIG. 6 is a perspective view illustrating the two halves of the golf bag secured together;

FIG. 7 is a perspective view illustrating a motorcycle equipped with saddle-bags comprising the present invention; and

FIG. 8 is an illustration of the use of the saddle-bags of FIG. 7 to receive and transport the golf bag of FIGS. 1-6, inclusive.

### DETAILED DESCRIPTION

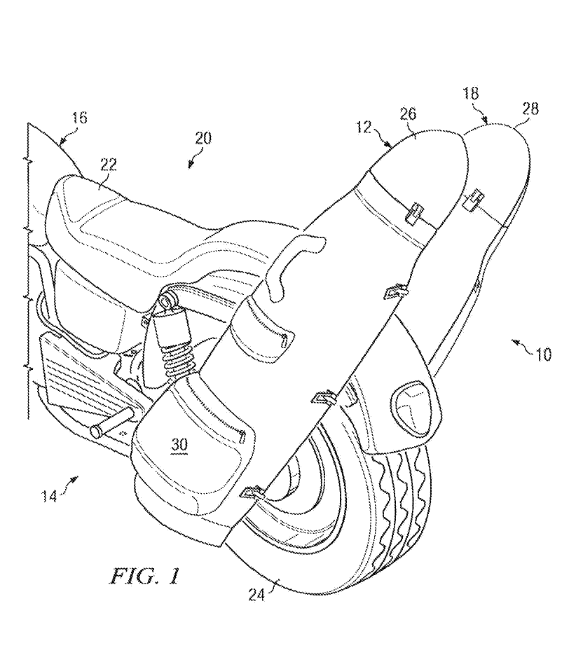

Referring to the drawings, and in particular to FIG. 1, there is shown a first half 12 of a golf bag 10 attached to a first side 14 of a motorcycle 16 and a second half 18 of the golf bag 10 attached to a second side 20 of the motorcycle 16 in order that the two halves of the golf bag 10 may be transported on the motorcycle 16. The two halves of the golf bag 10 are positioned to the rear of the seat 22 and substantially parallel to the rear wheel 24.

Each of the golf bag halves 12 and 18 comprises a planar surface defined by substantially parallel side edges, a top edge, and a bottom edge and a curvilinear surface defined by side edges which are secured to the side edges of the corresponding planar surface, a top edge comprising an extension of the top edge of the planar surface, and a bottom edge comprising an extension of the bottom edge of the planar surface. Each side wall half further comprises a bottom wall secured to the bottom edges of the planar surface and the curvilinear surface thereof. Each side wall half is provided with securing members which may comprise bayonet-type securing members. As will become more apparent hereinafter the securing members of the planar surfaces of the golf bag halves are employed to secure the golf bag halves to the opposite sides of a motorcycle and to secure the golf bag halves one to the other to form a complete golf bag.

The first half 12 of the golf bag 10 comprises a first end cap 26 that retains and protects the golf clubs stored within the bag, and the second half 18 comprises a similar second end cap 28. Both the first half 12 and the second half 18 of the golf bag 10 comprise one or more pockets 30 for receiving various items such as balls, tees, gloves, etc.

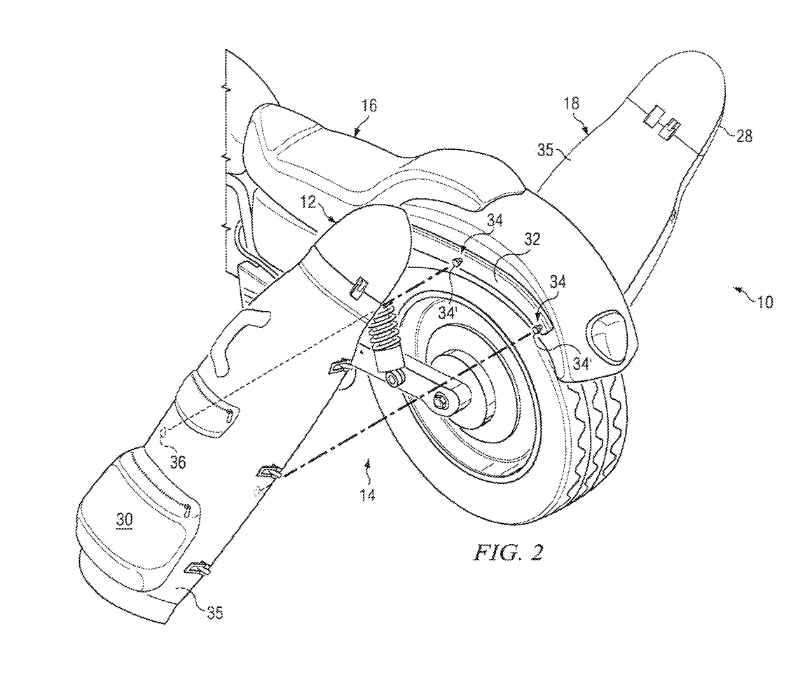

FIG. 2 is an exploded view of a first embodiment of a method of attaching the first half 12 of the golf bag 10 to the motorcycle 16. A frame 32 is built into the motorcycle 10 for receiving and supporting objects to the motorcycle 10. The frame 32 has two pins 34 that are used to secure objects to the motorcycle 10. The frame 32 and the pins 34 are well known in the art.

The frame 32 and pins 34 are used to attach and secure the first half 12 of the golf bag 10 to the motorcycle 16. The pins 34 engage apertures 36 formed in the planar surface 35 of the first half 12 of the golf bag 10 which faces the first side 14 of the motorcycle 16 thereby forming a bayonet-type connection between the golf bag half 12 and the first side 14 of the motorcycle 16. The pins 34 cannot be removed from the apertures 36 without raising the golf bag half 12 relative to the frame 32 of the motorcycle 16 thereby aligning the enlarged heads 34′ of the pins 34 with the enlarged upper portions of the apertures 36. The second half 18 of the golf bag 10 is attached to and removed from the motorcycle 16 in the same manner.

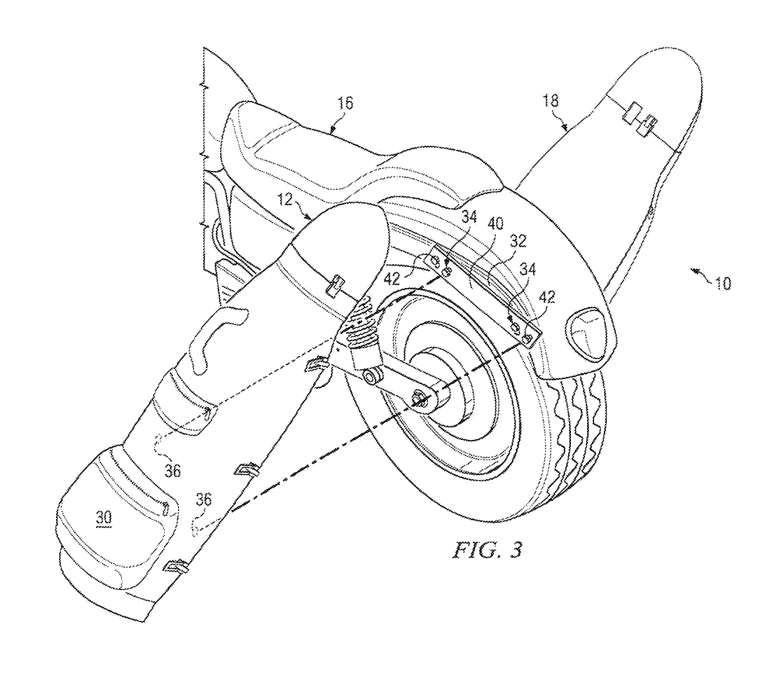

In FIG. 3 there is shown a second embodiment of the method of attaching the first half 12 of the golf bag 10 to the motorcycle 16 comprising the invention. In the second embodiment a bracket 40 is attached to the frame 32 of the motorcycle using the pins 34 described above. The bracket 40 has two pins 42 that protrude from the bracket for receiving the first half 12 of the golf bag 10. The pins 42 are received in the two slotted apertures 36 formed in the planar surface 35 of the first half 12 of the golf bag 10 facing the first side 14 of the motorcycle 16. The pins 42 slide vertically through the slot apertures 36 and into a tighter portion of the apertures creating a secure connection such that the first half 12 of the golf bag 10 is not unintentionally removed from the motorcycle 16.

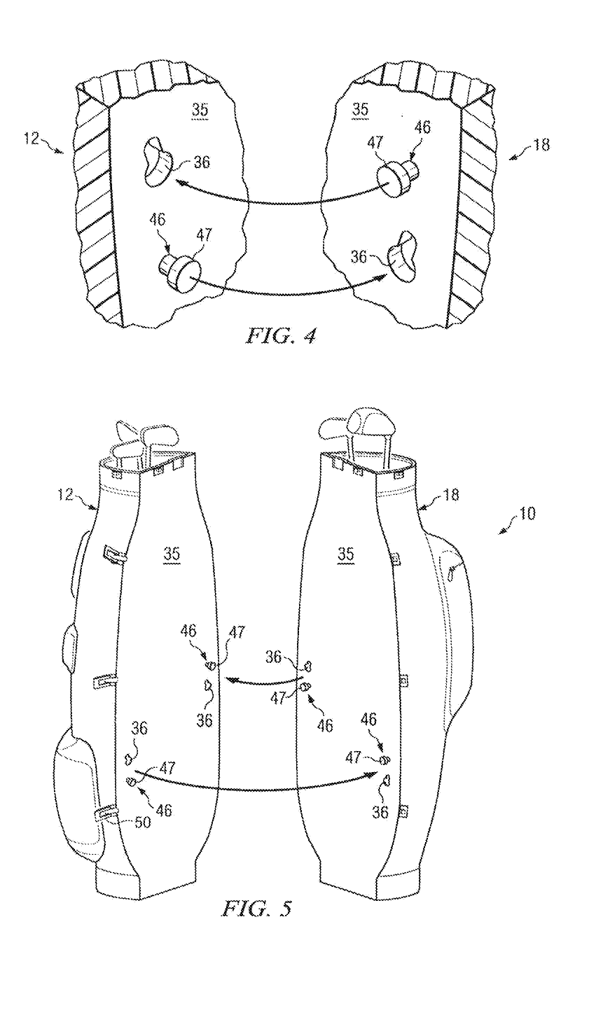

In FIG. 4 there is shown an enlarged view of the means for attaching the first half 12 to the second half 18 of the golf bag 10 when the two halves of the golf bag have been removed from the motorcycle. FIG. 5 is a perspective view further illustrating the connection of the two halves of the golf bag 10 one to the other. Pins 46 having enlarged heads 47 and the slot apertures 36 are provided on the planar interior surface 35 of the first half 12 of the golf bag 10. Corresponding pins 46 having enlarged heads 47 and the slot apertures 36 are provided on the planar interior surface 35 of the second half 18 of the golf bag 10. The pins 46 are inserted in to the slot apertures 48 and moved vertically through the slot apertures 36 until the enlarged heads 47 of the pins 46 are located behind the narrow portions of the slot apertures 36. In this manner the connection between the first half 12 and the second half 18 of the complete golf bag 10 is made secure. The bayonet-type connection of the first half 12 to the second half 18 of the golf bag 10 is further illustrated in FIG. 5. Toggle-type clamps 50 further secure the golf bag halves 12 and 18 to the other.

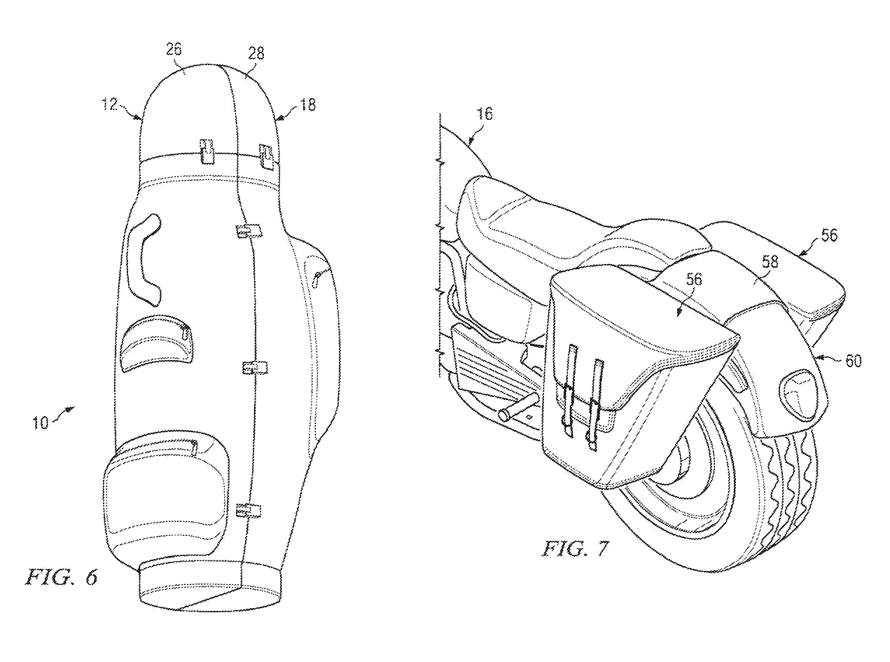

In FIG. 6 is a perspective view illustrating the two halves 12 and 18 of the golf bag 10 secured one to the other thereby forming a complete golf bag.

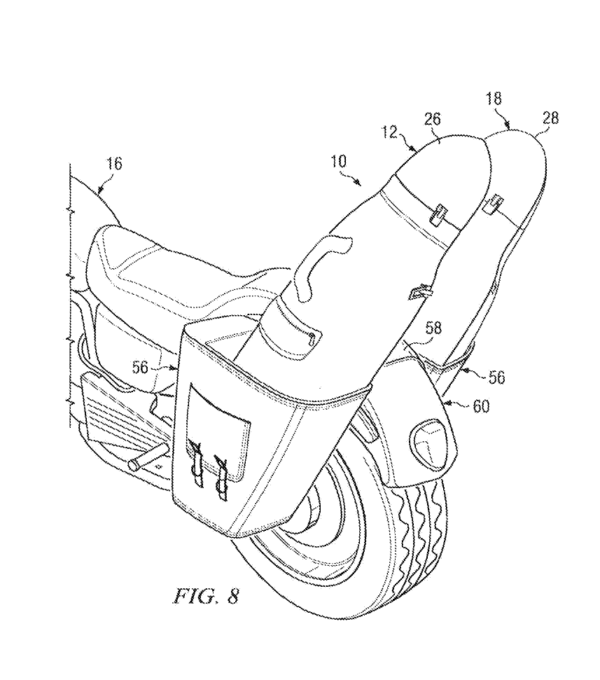

FIG. 7 illustrates a pair of saddle-bags 56 comprising the present invention. The saddle-bags 56 may be interconnected by a strap 58 which supports the saddle-bags 56 on the fender 60 of the motorcycle 16. Alternatively, the saddle-bags 56 may be secured directly to the fender 60 of the motorcycle 16, for example, by means of the pins 34 extending from the frame 32 shown in FIG. 2.

The saddle-bags 56 may be utilized in the manner of conventional saddle-bags for the transportation of various articles on a motorcycle 16. Alternatively, as is shown in FIG. 8, the saddle-bags 56 may be utilized to receive and transport the two halves 12 and 18 of the golf bag 10.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A golf bag comprising:
a first golf bag half including:
a first planar side wall defined by first and second side edges and top and bottom edges extending between the first and second side edges;
at least one securing member mounted on the planar surface comprising the first golf bag half;
a first curvilinear side wall defined by a first side edge secured to the first side edge of the first planar side wall, a second side edge secured to the second side edge of the first planar side wall, a top edge comprising a continuation of the top edge of the first planar side wall, and a bottom edge comprising a continuation of the bottom edge of the first planar side wall; and
a bottom wall secured to the bottom edges of the first planar side wall and the first curvilinear side wall;
a second golf bag half including:
a second planar side wall defined by first and second side edges and top and bottom edges extending between the first and second side edges;
at least one securing member mounted on the planar surface comprising the second golf bag half;
a second curvilinear side wall defined by a first side edge secured to the first side edge of the second planar side wall, a second side edge secured to the second side edge of the second planar side wall, a top edge comprising a continuation of the top edge of the second planar side wall, and a bottom edge comprising a continuation of the bottom edge of the second planar side wall;
a bottom wall secured to the bottom edges of the second planar side wall and the second curvilinear side wall;
the securing member mounted on the first planar side wall of the first golf bag half being positioned and adapted for engagement with the securing member on the second planar side wall of the second golf bag half to define means for securing the first and second golf bag halves in engagement one with the other to form a complete golf bag.

2. The golf bag according to claim 1 further including:
a motorcycle comprising a front wheel, a rear wheel, and a seat positioned between the front wheel and the rear wheel;
securing members mounted on the motorcycle behind the seat and on opposite sides of the rear wheel;
the securing members on the motorcycle being adapted and positioned for securing engagement with the securing members on the planar surfaces of the first golf bag half and the second golf bag half and defining means for mounting the golf bag halves on opposite sides of the motorcycle for transportation thereby.

3. The golf bag according to claim 2 further including a pair of frames mounted on the motorcycle on opposite sides of the rear wheel and wherein the securing members of the motorcycle are mounted on the frames.

4. The golf bag according to claim 3 further including a pair of brackets each detachably secured to one of the frames and wherein the securing members of the motorcycle are mounted on the brackets.

5. The golf bag transportation system according to claim 2 wherein the securing means on the planar surfaces of the golf bag halves and the securing means on the motorcycle comprise bayonet-type connections.

6. A golf bag transportation system comprising:
a motorcycle comprising a front wheel, a rear wheel, and a seat positioned between the front wheel and the rear wheel;
securing means mounted on the motorcycle behind the seat and on opposite sides of the rear wheel;
a pair of golf bag halves each comprising a planar surface, a curvilinear surface secured to the planar surface to define a golf club receiving interior, and a bottom surface secured to the lower edges of the planar surface and the curvilinear surface;
securing means mounted on the planar surface of each golf bag half;
the securing means on the planar surfaces of the golf bag halves and the securing means on the opposite sides of the motorcycle adapted for securing engagement with one another to define means for securing the golf bag halves to opposite sides of the motorcycle for transportation thereby.

7. The golf bag according to claim 6 further including a pair of frames mounted on the motorcycle on opposite sides of the rear wheel and wherein the securing members of the motorcycle are mounted on the frames.

8. The golf bag according to claim 7 further including a pair of brackets each detachably secured to one of the frames and wherein the securing members of the motorcycle are mounted on the brackets.

9. The golf bag transportation system according to claim 6 wherein the securing means mounted on the planar surfaces of the golf bag halves are positioned and adapted for securing engagement with one another to define means for securing the golf bag halves together and thereby forming a complete golf bag.

10. The golf bag transportation system according to claim 6 wherein the securing means on the planar surfaces of the golf bag halves and the securing means on the motorcycle comprise bayonet-type connections.
